(19) United States
(12) Patent Application Publication
(10) Pub. No.: US 2024/0242487 A1
(43) Pub. Date: Jul. 18, 2024

(54) TRANSFER LEARNING IN IMAGE RECOGNITION SYSTEMS

(71) Applicant: SOUL MACHINES LIMITED, Auckland (NZ)

(72) Inventors: Jonathan Conde, Auckland (NZ); Alireza Nejati, Auckland (NZ); Nathan Pages, Auckland (NZ)

(21) Appl. No.: 18/562,924

(22) PCT Filed: May 23, 2022
(86) PCT No.: PCT/IB2022/054803

§ 371 Date: Nov. 21, 2023

(30) Foreign Application Priority Data
May 21, 2021 (NZ) 776441

(51) Int. Cl. G06V 10/774; G06V 10/764; G06V 10/82

(52) U.S. Cl. CPC G06V 10/7747; G06V 10/764; G06V 10/82

(57) ABSTRACT

Visual Prompt Tuning provides fine-tuning for transformer-based vision models. Prompt Vectors are added as additional inputs to Vision Transformer models. alongside image patches which have been linearly projected and combined with a positional embedding. The transformer architecture allows prompts to be optimized using gradient descent. without modifying or removing any of the Vision Transformer parameters. A Image Recognition System with Visual Prompt Tuning improves a pre-trained vision model by adapting the pre-trained vision model to downstream tasks by tuning the pretrained vision model using a visual prompt.

### TECHNICAL FIELD

Embodiments of the invention relate to machine learning. More particularly but not exclusively, embodiments of the invention relate improving computer vision/image recognition and improving methods of transfer learning, namely efficient transferring learning for visual tasks via continuous optimisation of prompts.

### BACKGROUND ART

Traditional methods for adapting pre-trained vision models to downstream tasks involve fine-tuning some or all of the parameters of the model. There are a few trade-offs involved with this approach: change too many parameters, and the model may lose some of the benefits of pre-training (such as the ability to generalise); change too few, and the model may not adapt very well to the downstream task.

Transfer learning is an effective method for training neural network models on new tasks, starting from parameters that have been learned to solve a different problem. This allows the network to leverage knowledge common to both the original and the new tasks, and is of particular use when applying large, general models in novel or specific contexts. There are several approaches to transfer learning. In plentiful-data settings, the entire network can be trained on the new task. When data is scarce, however, this approach may increase generalisation error as the network “forgets” some of the knowledge it learned originally. For such problems, the network can be used as the “core” of a larger model with additional components (such as a classifier network that converts the output features of the core network into probability vectors), and those other components can be trained while keeping the core network frozen. In the domain of Natural Language Processing (NLP), large-scale pre-trained models can be adapted to new tasks without additional training, by prompting a model, during inference time, with some appropriate text. For example, a language model pre-trained on a large text corpus can be made to summarise a body of text by prepending the sentence “Provide a summary of the following text”, or appending the idiom “TL;DR:”. Thus the problem of adapting a network to a new task becomes a problem of manually engineering a good prompt for that task. Applying this concept to computer vision, methods such as CLIP have used joint contrastive training to encode mappings from text and images into a common feature space.

### OBJECT OF INVENTION

It is an object of the invention to improve computer vision, image recognition and/or transfer learning, or to at least provide the public or industry with a useful choice.

### BRIEF DESCRIPTION OF DRAWINGS

FIG. 1 shows a method of training a Image Recognition System with Visual Prompt Tuning ;

FIG. 2 shows a Image Recognition System with Visual Prompt Tuning;

FIG. 3 shows a Image Recognition System with Visual Prompt Tuning using a probe method;

FIG. 4 shows a Image Recognition System with Visual Prompt Tuning using a Zero Shot method;

FIG. 5 shows Hyperparameters used for Visual Prompt Tuning;

FIG. 6 shows a Vision Transformer with Visual Prompt Tuning;

FIG. 7 shows a comparison of the test error rate of the Visual Prompt Tuning with Linear classier combined methods;

FIG. 8 shows a comparison of the test error rate of the Zero Shot and Visual Prompt Tuning methods;

FIG. 9 shows test accuracy vs. number of labelled examples per class when using the Linear or Visual Prompt Tuning methods.

### DISCLOSURE OF INVENTION

### Summary

Visual Prompt Tuning provides fine-tuning for transformer-based vision models. Prompt Vectors are added as additional inputs to Vision Transformer models, alongside image patches which have been linearly projected and combined with a positional embedding. The transformer architecture allows prompts to be optimized (for example, using gradient descent), without modifying or removing any of the Vision Transformer parameters. In other words, an Image Recognition System with Visual Prompt Tuning improves a pre-trained vision model by adapting the pre-trained vision model to downstream tasks by tuning the pretrained vision model using a visual prompt.

The Image Recognition System may be used for any suitable computer vision task, including, but not limited to, tasks such as image classification, detection, localization, segmentation, object counting, and natural language reasoning on images.

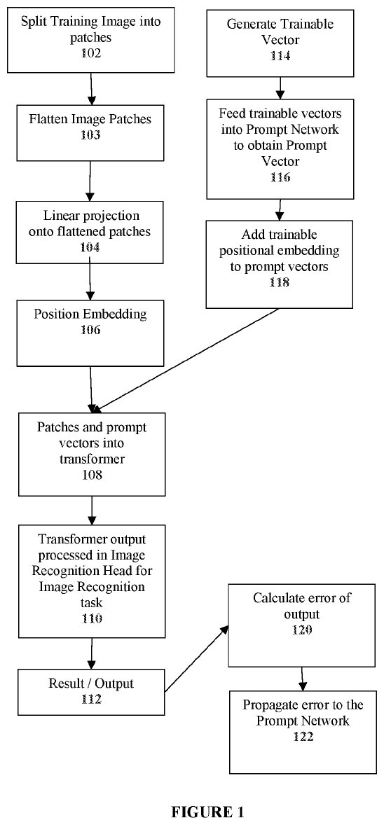

FIG. 1 shows a method of training an Image Recognition System with Visual Prompt Tuning. At step 102, a Training Image is split into patches, creating Image Patches. The Image Patches are flattened into a vector (step 103). Following this, a Linear Projection of Flattened Patches is created (step 104). Positional encoding/Position Embedding is added to the Linear Projection of Flattened Patches (step 106).

Trainable Vectors are generated or received (114). Trainable Vector values may be initialized to zero, randomized or initialized in any other suitable manner. The Trainable Vectors are input into a Prompt Network to obtain Prompt Vectors (step 116) in the image (token/embedding) space. Optionally, trainable position embeddings are added to the Prompt Vectors at step 118. In a forward pass, the Linear Projection of Flattened Patches is input into a Vision Transformer, along with the Prompt Vectors (which may include positional embeddings) at step 108.

The output of the Vision Transformer is input into a Image Recognition Head, such as a multi-layer perceptron, to classify the Training Image (step 110). In a backward pass, the error of the output classification (112) is calculated (step 120) and propagated to the Prompt Network (step 122). The Prompt Network weights and Trainable Vector weights are modified to reduce the error (using any suitable technique known in the art of machine learning).

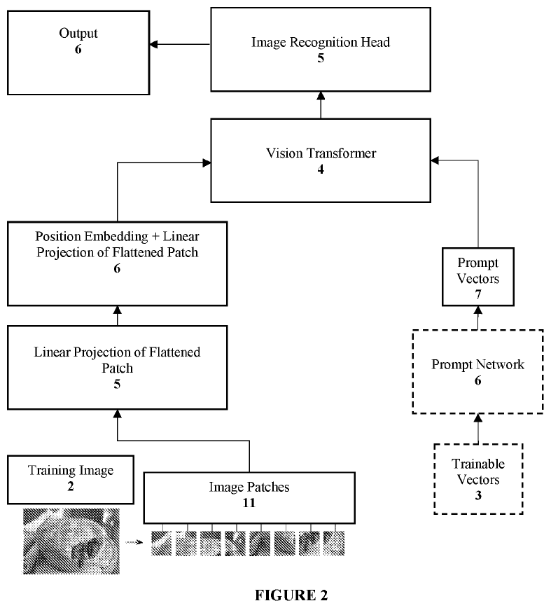

FIG. 2 shows a Image Recognition System with Visual Prompt Tuning. During Visual Prompt Tuning, the parameters shown with a dotted border are updated/trained (the Prompt Network weights and the Trainable Vector 3 values).

### Fine-Tuning

Visual prompt tuning is a transfer learning method that preserves the weights of a vison transformer model (which is pretrained) but fine-tunes on tasks by adding an auxiliary prompt input. During fine-tuning, the trained Vision Transformer remains fixed while the task-specific prompts are updated. The following methods of fine-tuning the pre-trained model (pre-trained vision transformer) are provided.

### Visual Prompt Tuning

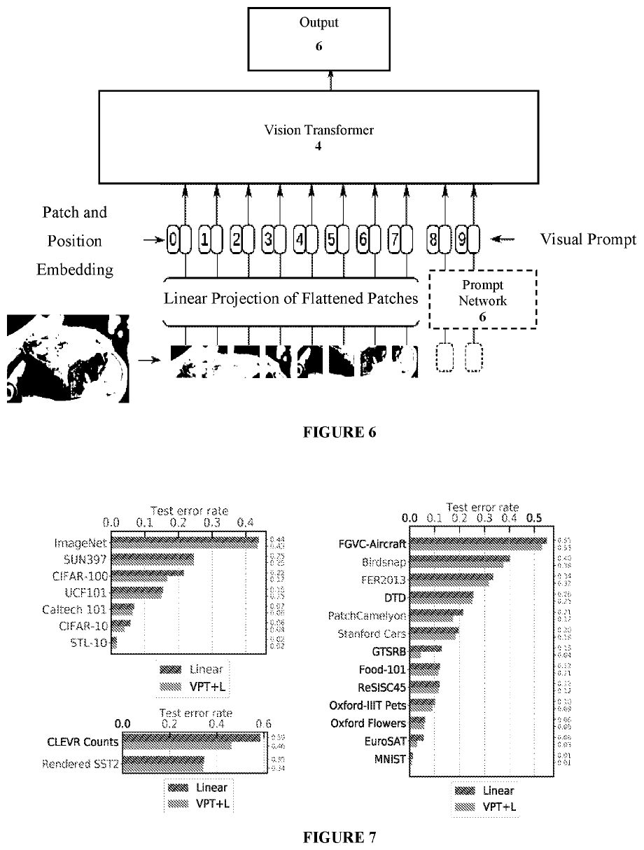

FIG. 6 shows a Vision Transformer with Visual Prompt Tuning. During visual prompt tuning, the parameters shown with a dotted border are trained. The parameters may be trained using a training data set including labelled images.

The first layer of the image encoder is a strided convolution (stride is the distance between spatial locations where the convolution kernel is applied), which effectively breaks the input image into a grid of patches, flattens the resulting tensors into vectors and projects each of these into a lower-dimensional space using a learned linear transformation - creating a Linear Projection of Flattened Patches 10. After that, the encoder adds a learned positional embedding to each vector. Ordinarily, these vectors, together with the learned “class” embedding, are the only inputs to the Transformer proper.

For Visual Prompt Tuning, additional inputs (the “prompt” or Prompt Vectors) are input into to the Transformer, bypassing the convolution and the positional embedding. This does not require architectural changes to the Transformer itself, because it is agnostic to the number of inputs. The prompt can be trained directly using gradient descent or in any other suitable manner. Any other suitable network, such as a multi-layer perceptron (MLP), may generate the prompt from trainable input vectors. The latter approach may improve the results for prefix-tuning. An MLP may be trained, with positional embedding added to its outputs. The MLP and positional embedding are only needed for training; at inference time, the generated prompts are fixed, so the same pre-computed prompts can be used for all input images.

To use this modified model as a classifier, the Transformer output is compared with the encoded text labels from the zero-shot approach. It is possible to prefix-tune the text encoder (at the same time as Visual Prompt Tuning), which may improve performance, but increase training time.

In visual prompt tuning, the input to the pre-trained vision transformer is modified to adapt the vision transformer for a downstream vision task. The pre-trained vision transformer is not trained/modified during the downstream training. The additional input (task-specific training parameters) are concatenated into input sequences of the pre-trained vision transformer and may be learned together with the image recognition head during fine-turning

In one embodiment, Prompt Vectors are only inserted into the first layer of the Vision Transformer, however the invention is not limited in this respect. Visual Prompt Tuning prompt parameters may be only inserted into the first layer of the Vision Transformer's input. Only the parameters of prompts and linear head are updated during visual prompt tuning training, while the whole Transformer encoder is fixed. Alternatively, prompt parameters may be introduced at a plurality of layers of the trained Vision Transformer, up to every layer of the trained Vision Transformer. A set of prompts may be attached to each input layer of the Vision Transformer (in other words, a set of learnable parameters is concatenated to each Transformer encoder layer's input).

### Zero-Shot Method

A zero-shot method does not train any existing or additional parameters. Using a zero-shot method, a Vision Transformer can be used as zero-shot classifiers (i.e. without any fine-tuning), by feeding images to the vision transformer (CNN) and class labels to a text transformer. The zero-shot method uses Feature Vectors from aligning text and images. The output is akin to a natural language embedding (e.g. a natural language sentence describing the image). Class labels may be generated on the fly. The zero-shot model jointly trains an image encoder and a text encoder to predict the correct pairings of a batch of (image, text) training examples. At test time the learned text encoder synthesizes a zero-shot linear classifier by embedding the names or descriptions of the target dataset's classes.

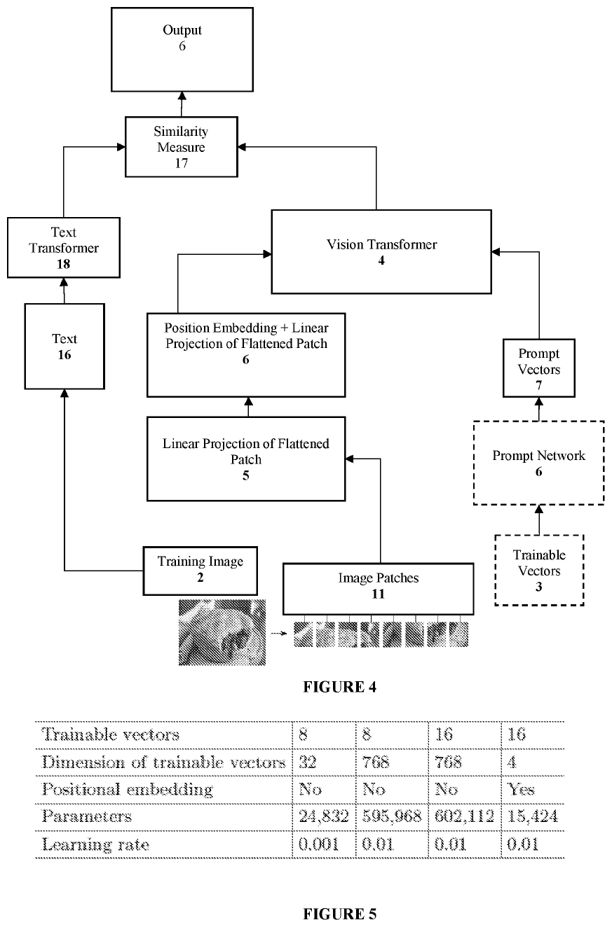

FIG. 4 shows a Image Recognition System with Visual Prompt Tuning using a Zero Shot method. Text associated with a Training Image is input into a Text Transformer. Feature Vectors from the Text Transformer and from the Vision Transformer are compared using a Similarity Measure 17 (e.g. dot product). A. Radford et al., “Learning transferable visual models from natural language supervision,”264 arXiv preprint, 2021. https://arxiv.org/abs/2103.00020 describes a zero-shot model generating output in a joint language and image embedding space.

### Training a Linear Classifier Probe Method

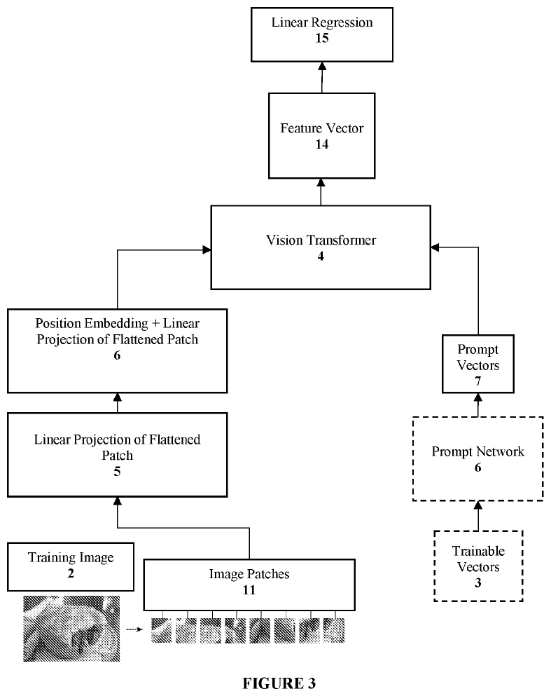

In a probe method, a linear regression model is learned on the output (a linear probe). FIG. 3 shows a Image Recognition System with Visual Prompt Tuning using a probe method. The final layer of the Vision Transformer (a linear projection) is replaced so that its output dimension matches the number of classes of the training data. The linear classifier is included as part of the parameters to be trained (linear probe). In other words, the Image Recognition Head is trained using the feature vectors 14 output by the Vision Transformer using a linear model (e.g. linear regression 15). Training the Image Recognition Head may improve the output performance or may enable a different kind of image recognition task to be carried out from that of the vision transformer.

### Combined Visual Prompt Tuning and Linear Classifier

Combining Visual Prompt Tuning with visual prompt tuning (also known as prefix-tuning) may improve few-shot performance. Instead of using encoded text labels, the final layer of the image encoder is replaced and trained together with the prompt.

### Method Details

Image transformers are known to those skilled in the art of computer vision/machine learning. An example of a vision transformer is detailed in: Dosovitskiy, Alexey, et al. “An image is worth 16×16 words: Transformers for image recognition at scale.” arXiv preprint arXiv:2010.11929 (2020), incorporated by reference herein.

### Pretraining

A trained Vision Transformer (trained/pretrained model) may be provided in any suitable manner. In one embodiment, the Vision Transformer may comprise an image encoder and a text encoder, which both output real-valued vectors (with the same shape). For example, the Vision Transformer component of CLIP may be used as the pre-trained model (Radford, A., et al.: Learning transferable visual models from natural language supervision. In: ICML (2021)). To classify an image using CLIP, one can encode it and compare the resulting vector with several encoded text labels, using cosine similarity. Similarly, one can classify a string of text in terms of a set of image “labels”. CLIP can classify images given any number of text labels, without additional fine-tuning.

### Image Patch Embeddings

Each image is divided into small “patches” of a fixed size. The input sequence consists of a flattened vector (e.g. from 2D image pixels to ID) of pixel values. Each flattened element is fed into a linear projection layer to produce “Patch embedding”. Position embeddings are then linearly added to the sequence of image patches to enable images to retain their positional information, thus injecting information about the relative or absolute position of the image patches in the sequence.

An extra learnable (class) embedding is attached to the sequence according to the position of the image patch. This class embedding is used to predict the class of the input image after being updated by self-attention. The classification is performed by stacking an MLP Head on top of the Transformer, at the position of the extra learnable embedding added to the sequence.

### Hyperparameters for Visual Prompt Tuning

FIG. 5 shows Hyperparameters used for visual prompt tuning. Each column represents a distinct hyperparameter selection. When tuning hyperparameters inserting a fully-connected layer may outperform tuning the prompts directly, or using a deep Prompt Network. In one embodiment, a fully-connected network with hundreds of inputs is used. The inventors found that as few as four inputs worked well for some datasets, after a “positional embedding” is added.

Without any positional embedding:

$$prompt i = fully ‐ connected ( weights i )$$

Depending on the data set, any suitable number of inputs may work after adding a “positional embedding.” Specifically, Prompt Vectors are computed follows:

$$prompt i = fully ‐ connected ( weights i ) + position i ,$$

where position is a trainable matrix with the same dimensions as the prompt.

The Prompt Network may help to decouple learning the concepts involved in the prompt from their representations. For example, useful prompt vectors for the German Traffic Sign Recognition Benchmark dataset (GTSRB) are likely related to traffic signs in some way, and consequently belong to a low-dimensional subspace of the input feature space.

As the final layer of the Prompt Network learns to output elements of this subspace, the benefits can be shared by all the Prompt Vectors, not just those which could learn how to represent some generic concepts in this space. Its inputs, (analogous to weights), should then combine these concepts in useful ways. Without the Prompt Network, each Prompt Vector learns independently of the others, so it may take longer to settle on a collection of similar vectors. The Prompt Network can also learn features specific to one prompt vector, at the cost of reducing the availability of “shared” parameters. Other Prompt Vectors may accidentally pick up these features while training. In each training step, the positional embedding is able to move outside the current range of the Prompt Network, which may encourage each prompt vector to encode unique features. This allows us to use a relatively small Prompt Network, to encode only the shared features.

### Loss Function of the Prompt Network

Any suitable loss function may be used for the Prompt Network and/or Image Recognition Head, including but not limited to cross entropy, means squared error, or L₀/L₁. For single-class images, cross entropy may be used as the loss function of the Prompt Network. For datasets with multiple classes per image binary cross entropy may be suitable (effectively training one binary classifier per class).

### Back-Propagation (Optimization)

Any suitable method of first order gradient-descent based method may be used for training the Prompt Network, Trainable Vectors and/or Image Recognition Head. In one embodiment, a method of stochastic optimization as described in: D. P. Kingma and J. Ba, “Adam: A method for stochastic optimization,” in International 280 Conference on Learning Representations, 2015 is used in a backward pass. However the invention is not limited in this respect, any other suitable method may be used, such as the L-BFGS algorithm.

### Training Details

Any suitable initial learning rate may be used for the Prompt Network, such as between 0.01 to 0.001. Once the validation loss plateaus, learning rate may be reduced. For example, the learning rate may be reduced by a factor of 10. Training may be stopped if the validation metric (usually accuracy) had not improved for several epochs. The validation set may be included in the training data for a final session, reusing the best known hyperparameters.

Models may be trained on graphics cards or any other suitable hardware. The hardware may have automatic mixed precision.

Regarding the zero-shot method, in classification tasks, classification scores may be improved by using several labels for each class and averaging the corresponding feature vectors or prefix-tuning the labels (as described in: A. Radford et al., “Learning transferable visual models from natural language supervision,”264 arXiv preprint, 2021. https://arxiv.org/abs/2103.00020.)

### Example Implementations of a Transformer

Any suitable transformer architecture may be used. Details of a transformer are detailed below, as an example, even though this transformers are known to those skilled in the art of machine learning.

In one embodiment, an encoder maps an input sequence of symbol representations to a sequence of continuous representations. The decoder then generates an output sequence of symbols one element at a time. The Transformer may use stacked self-attention and point-wise, fully connected layers for both the encoder and decoder.

### Attention Sub-Layers

The encoder is composed of a stack a suitable number of identical layers (e.g. 6 layers). Each layer has two sub-layers, a multi-head self-attention mechanism, and a positionwise fully connected feed-forward network. A residual connection is employed around each of the sub-layers, followed by layer normalization.

The decoder is composed of a stack a suitable number of identical layers (e.g. 6 layers). Each layer has a multi-head self-attention mechanism, and a positionwise fully connected feed-forward network. A third sublayer performs multi-head attention over the output of the encoder stack. A residual connection is employed around each of the sub-layers, followed by layer normalization. The self-attention sub-layer in the decoder stack is modified to prevent positions from attending to subsequent positions.

An attention function maps a query and key-value pairs to an output. The query, keys, values, and output are all vectors. The output is computed as a weighted sum of the values. Weight assigned to each value is computed by a compatibility function of the query with the corresponding key. Scaled Dot-Product Attention may be used as the attention function.

### Feed Forward Network

In addition to attention sub-layers, each of the layers in the encoder and decoder contains a fully connected feed-forward network, which is applied to each position separately and identically.

### Multi-Head Attention

It may be beneficial to linearly project the queries, keys, and values several times with different, learned projections to the dimensions. On each projected version of the queries, keys and values, the attention function is performed in parallel, yielding multidimensional output values, which are concatenated and once again projected, resulting in the final values. The model jointly attends to information from different representation subspaces at different positions.

In “encoder-decoder attention” layers, the queries come from the previous decoder layer, and the memory keys and values come from the output of the encoder. This allows every position in the decoder to attend over all positions in the input sequence.

The encoder contains self-attention layers. In a self-attention layer all of the keys, values and queries come from the same place, in this case, the output of the previous layer in the encoder. Each position in the encoder can attend to all positions in the previous layer of the encoder.

Self-attention layers in the decoder allow each position in the decoder to attend to all positions in the decoder up to and including that position.

### Position Embedding

Each input image is divided into fixed-size patches. Each patch is embedded into a latent space with positional encoding. Since the model does not include recurrence or convolution, in order for the model to make use of the order of the sequence, information about the relative or absolute position of the tokens in the sequence must be embedded. Position Embeddings are added to the input embeddings at the bottoms of the encoder and decoder stacks. The positional encodings have the same dimension as the embeddings, so that the two can be summed. Learned or fixed embeddings may be used.

### Vision Transformer

Any suitable Transformer architecture may be adapted to create a Vision Transformer. Training Images are split into fixed-size Image Patches. Each of the Image Patches are linearly embedded. Position Embeddings are added. The resulting sequence of vectors is input into a standard Transformer.

The standard Transformer receives as input a ID sequence of token embeddings. To handle two dimensional images, images are reshaped into a sequence of flattened two-dimensional patches. The number of patches is the image sequence length for the transformer. The transformer uses a constant latent vector size through its layers. The Image Patches are flattened and mapped into the latent vector size dimensions, with a trainable linear projection, creating Patch Embeddings.

A learnable embedding is prepended to a sequence of Patch Embeddings whose state at the output of the transformer encoder serve as an image representation. During pre-training and fine-tuning, a classification head may be attached to the output of the Transformer encoder. The classification head may be implemented by a multilayer perceptron with a hidden layer at pre-training and a single linear layer at fine tuning.

Position Embeddings are added to Patch Embeddings to retain positional information. Standard learnable one-dimensional Position Embeddings, two-dimensional-aware Position Embeddings, or any other suitable Position Embedding may be used. The resulting sequence of embedding vectors is input into the transformer encoder.

The Vision Transformer is pretrained on large datasets and then fine-tuned to smaller downstream tasks. For fine-tuning, the pre-trained prediction head of a transformer is removed, and a zero-initialized feedforward layer is added, with a number of downstream classes. Optionally, the transformer is fine-tuned at a higher resolution than pre-training. When feeding images at a higher resolution, patch sizes may be kept the same. 2D interpolation of pre-trained position embeddings may be carried out, according to their location in the original image. The resolution adjustment and patch extraction manually injects an inductive bias about the two-dimensional structure of the images into the Vision Transformer.

### Hybrid Architecture

As an alternative to raw image patches, the input sequence can be formed from feature maps of a convolutional neural network. A patch embedding projection is applied to patches extracted from a convolutional neural network feature map. The patches can have spatial size 1×1, which means that the input sequence is obtained by flattening the spatial dimensions of the feature map and projecting to the Transformer dimension. The classification input embedding and position embeddings are added as described above.

### Alternative Embodiments and Applications

Visual Prompt Tuning is an effective approach to learning faster and with much less data. Since Visual Prompt Tuning does not modify the core model, the same model can be used for several different tasks (even within the same mini-batch). This may be useful in developing more complete models of the human visual system, which is capable of much more than just classification.

The pre-training procedure may take multiple tasks into account (e.g. CLIP models are much better at classification than semantic segmentation).

Visual prompts could be used by a cloud-based provider to efficiently run classifiers for several different organisations at the same time, or even different users within the same organisation. One could even employ several different levels of Tuning: for instance, part of the prompt could improve traffic sign classification, and another part could be tuned for traffic signs in a specific country. Visual Prompt Tuning may be employed on tasks other than classification.

Visual prompts may be visualized, either by optimising them at the image patch level, or by prompt tuning the encoder part of an autoencoder.

Other techniques for transfer learning in NLP, such as adapter tuning, may also work with vision transformers.

### Advantages

In the context of vision transformers, Visual Prompt Tuning may be advantageous compared to full (end-to-end) fine-tuning as it may be more efficient, and just as (if not more) effective.

Prompts improve the performance of Transformers on visual tasks. This makes intuitive sense when considering optical illusions involving color, where the color of one part of an image can alter the perception of color in another part. Since Transformers multiply their inputs with each other, it has been hypothesized they are good at learning contextual representations, in other words, the representation of an input token is modulated by the other tokens. Prompts may serve to locate a particular task in the space of all tasks the model has learned. A Transformer trained on diverse visual data will learn a variety of tasks, such as recognizing both photographs and sketches of particular objects. Prompting it can then “prime” the network to solve a task more relevant to a specific domain.

Adding a small number of additional parameters to a pre-trained model, Visual Prompt Tuning obtains similar performance to fine-tuning in the full-data setting and outperforms it in low-data settings. In addition, Visual Prompt Tuning offers marked increase in accuracy for specialized tasks such as traffic sign recognition, satellite photo recognition, and handwriting classification.

Visual Prompt Tuning may improves fine-tuning performance on downstream visual tasks. Visual Prompt Tuning, or Visual Prompt Tuning in combination with fine-tuning of a linear classifier, outperforms fine-tuning alone for many classification tasks, especially when data is scarce or the task differs significantly from the one used for pre-training.

Visual Prompt Tuning improves accuracy for specialized datasets & tasks that seem ‘out of domain, in particular, tasks where the training images differ substantially from natural images and other images likely to appear in the training set.

In prefix-tuning and adapter tuning, the parameters of the original network are preserved, whereas in fine-tuning they are modified. For the specific case of prefix-tuning in language models, the models are pre-trained on large general corpora, thus preserving the network parameters is desirable for generalization purposes. In adapter tuning, the number of trainable parameters is fixed (or at least bounded below) by both the input and output dimensions, whereas in prefix-tuning only the input dimension of the transformer is fixed. This flexibility allows prefix-tuning to match the performance of adapter tuning, but with fewer parameters.

An advantage of transformers is better learning of contextual representations, due to the presence of multiplicative interactions between inputs. Contextual representations are those that are modulated by other tokens in the input. Prompts serve to locate the particular task at hand in the space of all possible tasks the model has learned. In other words, pre-training a model on a large-scale general purpose corpus “teaches” it a variety of tasks, and then, during inference time, the prompt “primes” the network to solve a particular task among its repertoire of tasks. This view can help explain the efficacy of Visual Prompt Tuning, as similar reasoning also applies to the visual domain. For instance, recognizing human sketches of objects requires recognition of different forms of patterns as compared to, for example, recognizing photographs of objects. A network trained on diverse visual data encodes a variety of these forms of tasks in its weights. Prompts can serve to locate particular tasks and can thus succeed with relatively few parameters.

Vision Transformer models avoid using CNNs altogether, by passing (linear projections of) a grid of image patches directly to a transformer. The Vision Transformer approach has demonstrated better performance than contemporary CNNs if the training dataset is sufficiently large which aligns with the fact that transformer models lack the inductive biases of CNNs.

### EXPERIMENTAL DATA

Embodiments of the invention have been tested experimentally, as described in: Conder, J., Jefferson, J., Pages, N., Jawed, K., Nejati, A., Sagar, M. (2022). Efficient Transfer Learning for Visual Tasks via Continuous Optimization of Prompts. In: Sclaroff, S., Distante, C., Leo, M., Farinella, G. M., Tombari, F. (eds) Image Analysis and Processing—ICIAP 2022. ICIAP 2022. Lecture Notes in Computer Science, vol 13231. Springer, Cham. https://doi.org/10.1007/978-3-031-06427-2_25, incorporated by reference herein.

The experimenters trained each model on 2 Quadro RTX 8000 cards using automatic mixed precision, an initial learning rate ranging from 0.01 to 0.001, and a batch size of 512. It took a total of 3 weeks (averaging 51 min per run for few-shot classification, and 88 min per run for ordinary classification). For Caltech 101, CIFAR-100, and Oxford Flowers, the experimenters experimented with a wide variety of Visual Prompt Tuning hyperparameters. The experimenters found that training the prompt vectors directly lead to poor performance. On the other hand, using an MLP to generate the prompt was no better than a single fully-connected (FC) layer. The best performing choices, as shown in FIG. 5, were then used for visual prompt tuning across all the datasets. For instance, in the leftmost case, each prompt vector was generated by passing one of eight vectors through a linear map R32→R768. In the rightmost case, The experimenters instead used sixteen vectors in R4, and added the result to one of sixteen “positional embedding” vectors (in R768).

The experimenters used cross entropy as the loss function. Once the validation loss plateaued the learning rate was reduced by a factor of 10. Training was stopped if the validation metric (usually accuracy) had not improved for 15 epochs. The experimenters considered including the validation set in the training data for a final session, reusing the best known hyperparameters, but found the performance difference (on the test set) to be negligible in experiments. For few-shot classification, the experimenters only validated once every 10 epochs (as the validation sets were much larger than the new training sets), and the experimenters only used the best known hyperparameters for each dataset.

The experimenters' attempts to replicate the original zero-shot and linear classifier benchmarks for CLIP yielded slightly different results, for a number of possible reasons. For example, some of the experimenters' datasets (or the train/validation/test splits) did not match the originals exactly. For the zero-shot approach, the experimenters may have labelled some classes differently. Also, the experimenters' linear classifiers were trained differently (to facilitate combining them with Visual Prompt Tuning). The experimenters divided the datasets qualitatively into three categories: general-purpose classification (ImageNet, CIFAR-10, CIFAR-100, SUN397, 304 J.

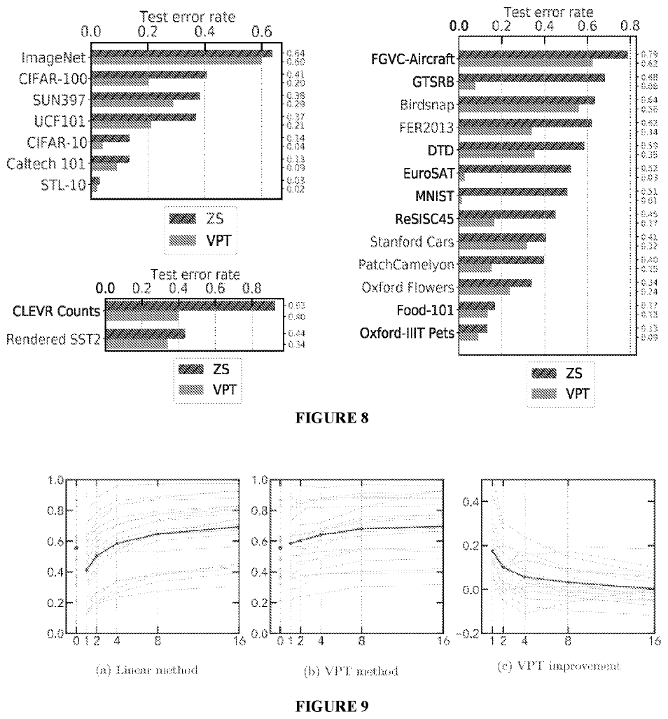

FIG. 8 shows a comparison of the test error rate of the Zero Shot and Visual Prompt Tuning methods, on general-purpose classification datasets (top left), specialized classification datasets (right) and non-classification datasets (bottom left). UCF101, STL-10, and Caltech 101\), specialized classification (FGVCAircraft, GTSRB, Birdsnap, FER2013, DTD, EuroSAT, MNIST, ReSISC45, Stanford Cars, PatchCamelyon, Oxford Flowers, Oxford Pets, Food 101), and specialized tasks that weren't classification tasks (CLEVR Counts and Rendered SST2).

FIG. 7 shows a comparison of the test error rate of the Visual Prompt Tuning with Linear classier combined methods, on general-purpose classification datasets (top left), specialized classification datasets (right) and non-classification datasets (bottom left). FIG. 7 presents the test error rate using the best per-dataset hyperparameter selections for the Visual Prompt Tuning with Linear classier combined methods. In the general-purpose classification sets, Visual Prompt Tuning offers a clear advantage for CIFAR-100 and CIFAR-10. For the specialized classification tasks, Visual Prompt Tuning improves accuracy for many of the datasets, especially EuroSAT and GTSRB. The experimenters see a general pattern of Visual Prompt Tuning improving the performance more for tasks that are domain specific, in particular, tasks where the training images differ substantially from natural images and other images likely to appear in the CLIP training set. As regards CIFAR-100 and CIFAR-10 benefiting from Visual Prompt Tuning, the images in those two datasets have a much lower resolution than those typically seen on the internet. Visual Prompt Tuning also offers a performance advantage for CLEVR Counts, however the baseline performance is already poor (˜60% error rate), thus accuracy with Visual Prompt Tuning is still relatively low.

FIG. 8 shows the test error rate for the best per-dataset hyperparameter selections for the Zero Shot and Visual Prompt Tuning methods. Here, the advantages of Visual Prompt Tuning are more pronounced, since the Zero Shot method does not use the training data. VTP provides even larger improvements for specialized datasets, especially for the EuroSAT and MNIST datasets, where Visual Prompt Tuning takes the error rate from nearly 50% to almost state-of-the-art.

FIG. 9 shows test accuracy (vertical axis) vs. number of labelled examples per class (horizontal axis) when using the Linear or Visual Prompt Tuning methods. The blue lines are the average of the accuracies over all the datasets (light gray lines). The zero-shot CLIP baseline is indicated by star. FIG. 9a presents the test accuracy of the linear classifier method when trained on only 1, 2, 4, 8 or 16 images per class. The test accuracy values reported at 0 are for the Zero Shot method. The experimenters observe that one-shot training of a linear classifier does not outperform the zero-shot method, except for a few datasets. For Oxford Pets and RenderedSST2, even 16-shot training underperforms. These results are coherent with the original benchmarks, which found that (on average) four images per class were required for a few-shot linear classifier to match zero-shot performance. FIG. 9b shows the test accuracy of the Visual Prompt Tuning method in the context of few-shot learning. Here, one-shot learning outperforms the zero-shot baseline in most cases. This demonstrates that Visual Prompt Tuning is a more robust approach to few-shot transfer learning than the linear classifier method. FIG. 9c compares the few-shot performance of the Visual Prompt Tuning and linear classifier methods directly. For all but one task, Visual Prompt Tuning outperforms the linear classifier method in the one-shot setting, and by about 20% on average. When more data is available the gap becomes smaller (as one might expect from FIG. 7 and FIG. 8). Overall Visual Prompt Tuning outperforms the Linear method when data is scarce.

### INTERPRETATION

The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. It will be understood that the arrangement and construction of the modules or engines may be adapted accordingly depending on system and user requirements so that various functions may be performed by different modules or engines to those described herein, and that certain modules or engines may be combined into single modules or engines. It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

### SUMMARY OF INVENTION

There is provided a computer-implemented method of training a Image Recognition System with Training Images, comprising: generating one or more Trainable Vectors; for each Training Image: inputting the Trainable Vectors through a Prompt Network to output Prompt Vectors; and inputting the Trainable Vectors and Linear Projection of Flattened Patches of the Training Images into a trained/pretrained Vision Transformer to train the Prompt Network and the Trainable Vectors.

Optionally, the Prompt Network is a multi-layer perceptron.

Optionally, the Prompt Network comprises a fully-connected layer.

Optionally, the method comprises adding trainable position embedding to Prompt Vectors.

Optionally, Prompt Network training comprises first-order gradient-based optimization of a stochastic objective function.

Optionally, classification scores of the transformer use several labels for each class and average the corresponding feature vectors.

Optionally, classifications of the transformer use prefix-tuned labels.

Optionally, the method further comprises an Image Recognition Head receiving output from the vision transformer, and producing image recognition output and wherein the Image Recognition Head is trained concurrently with the prompt network and trainable vectors.

There is also provided a computer-implemented method of training an Image Recognition System comprising a pretrained Vision Transformer and trainable input parameters, the method comprising the steps of: inputting the trainable input parameters as auxiliary parameters alongside labelled training images into the pretrained Vision Transformer, and modifying the trainable input parameters to reduce error with respect to the labelled training images.

There is also provided a method of performing an image recognition task using an Image Recognition System trained using the methods described above. The image recognition task may be performed by inputting an image to be classified into the trained Vision Transformer, alongside trainable input parameters trained using the methods described above.

1. A computer-implemented method of training an image recognition system with training images, comprising: generating or receiving one or more trainable vectors; for each training image:
i. inputting the trainable vectors through a prompt network to output prompt vectors; and
ii. inputting the trainable vectors and linear projection of flattened patches of the training images into a trained vision transformer to train the prompt network and the trainable vectors.

2. The method of claim 1, wherein prompt vectors are added to the first layer of the trained vision transformer.

3. The method of claim 1, wherein prompt vectors are added to a plurality of layers of the trained vision transformer.

4. The method of claim 1, wherein the prompt network is a multi-layer perceptron.

5. The method of claim 1, wherein the prompt network comprises a fully-connected layer.

6. The method of claim 1, wherein the method comprises adding trainable position embedding to prompt vectors.

7. The method of claim 1, wherein prompt network training comprises first-order gradient-based optimization of a stochastic objective function.

8. The method of claim 1, wherein classification scores of the transformer use several labels for each class and average the corresponding feature vectors.

9. The method of claim 1, wherein classifications of the transformer use prefix-tuned labels.

10. The method of claim 1, wherein the method further comprises an image recognition head receiving output from the vision transformer and producing image recognition output and wherein the image recognition head is trained concurrently with the prompt network and trainable vectors.

11. A data processing system comprising means for carrying out the method of claim 1.

12. A method of performing an image recognition task using an image recognition system trained using the method of claim 1.

13. A computer program comprising instructions which, when the program is executed by a computer, cause the computer to carry out the method of claim 1.

14. (canceled)

15. (canceled)

16. The method of claim 4, wherein the prompt network comprises a fully-connected layer.

17. The method of claim 16, wherein the method comprises adding trainable position embedding to prompt vectors.

18. The method of claim 16, wherein prompt network training comprises first-order gradient-based optimization of a stochastic objective function.

19. The method of claim 16, wherein the method further comprises an image recognition head receiving output from the vision transformer and producing image recognition output and wherein the image recognition head is trained concurrently with the prompt network and trainable vectors.

20. A data processing system comprising means for carrying out the method of claim 16.

21. A method of performing an image recognition task using an image recognition system trained using the method of claim 16.

22. A computer program comprising instructions which, when the program is executed by a computer, cause the computer to carry out the method of claim 16.
